(19) United States
(12) Patent Application Publication
(10) Pub. No.: US 2009/0306888 A1
(43) Pub. Date: Dec. 10, 2009

(54) Navigation device

(76) Inventors: Thomas May, Wolfenbuettel (DE); Wolfgang Kopmann, Hildesheim (DE)

Correspondence Address: KENYON & KENYON LLP, ONE BROADWAY, NEW YORK, NY, 10004, US

(21) Appl. No.: 11/658,898

(22) PCT Filed: May 31, 2005
(86) PCT No.: PCT/EP05/52470

§ 371 Date: May 18, 2009

(30) Foreign Application Priority Data
Jul. 28, 2004 (DE) 102004036564.4

(51) Int. Cl. G01C 21/36

(52) U.S. Cl. 701/207

(57) ABSTRACT

A navigation device including a device, provided for mobile use, having input and output means, having a processor for processing software, having a navigation software for position determination and for route computation, and having a first interface for transmitting data into and/or out of the device, wherein the first interface is developed, in the operation of the device in a motor vehicle, to read operating and/or sensor data of at least one vehicle component into the device via a second interface and a data carrier having a navigation software for use in a device provided for mobile use, the navigation software including a software module which utilizes operating data, read in via an interface of the device, of a vehicle in which the device is operated or sensor data from sensors situated in the vehicle, for position determination or for determining a state of motion of the vehicle. The present invention has the advantage that navigation devices based on devices provided for mobile use, especially so-called hand-held computers, and also PDA (personal digital assistant), mobile radio telephones and the like are improved. In particular, the accuracy of the position determination in such navigation devices is decidedly improved.

### FIELD OF THE INVENTION

The present invention relates to a navigation device and a data carrier having navigation software.

### BACKGROUND INFORMATION

Navigation devices for operating motor vehicles are known which are usually installed in a center console or a dashboard of a motor vehicle. These regularly have operating elements for inputting a destination instruction. Moreover, they regularly have software for determining a respectively current vehicle location and for computing a travel route from the location to the input destination. A current location, in this context, is determined based on data from a satellite receiver, installed in the vehicle, for GPS (global positioning system) satellite signals and frequently also from signals from, for example, gyro sensors or acceleration sensors, a speed signal or the like. In addition, these navigation devices also have output means for directing a driver along a computed travel route, travel direction instructions being mostly output as spoken instructions, especially turn-off instructions, and/or as a travel direction indication on a display.

For instance, at the International Broadcast Exhibition 2001 in Berlin, such a vehicle navigation device of the type “Online Pilot” from the firm Blaupunkt GmbH was introduced, in which the relatively large display of a handheld PC, also known as PDA (personal digital assistant), was used for the additional display of a road map for the improved orientation of the driver. For this, data about the current vehicle location were transmitted via an interface of the navigation device and an interface of the PDA into the latter.

It is provided in German Patent Application No. DE 199 12 742 to transmit a travel route, computed in a vehicle navigation device, via an interface to a device provided for mobile use, in this case, for instance, a mobile radio telephone, so that the route data are able to be output by the mobile radio telephone separately from the vehicle navigation device.

Furthermore, navigation devices have become known that are based on handheld PC's, the handheld PC having available input and output means, a processor for processing a software, a software for determining position based on the signals of a connectable GPS satellite receiver, a navigation software, as well as map data for route computation and an interface for connecting the GPS satellite receiver. The result of the route computation is then, for instance, output as a map section via the display of the device.

### SUMMARY OF THE INVENTION

The present invention has the advantage that navigation devices based on devices provided for mobile use, especially so-called handheld computers, and also PDA (personal digital assistant), mobile radio telephones and the like are improved. In particular, the accuracy of the position determination is decidedly improved in such navigation devices.

For this purpose, a device provided for mobile use, based on which the navigation device according to the present invention is implemented, has input and output means, a processor for processing software, a navigation software for position determination and for route computation, and an interface for transmitting data to the device, this interface being designed to read into the device operating and/or sensor data of at least one vehicle component, when the device is used in a motor vehicle.

The navigation software present in the device advantageously utilizes the operating and/or sensor data, read in via the interface, for the position determination and/or for determining a state of motion of the vehicle.

It is advantageously provided that the operating and/or sensor data, read in via the interface of the device, are signals of at least one wheel sensor, a speed signal, signals of at least one acceleration sensor, signals of at least one gyroscope and/or signals of detection of the vehicle in reverse.

According to one advantageous refinement of the present invention, the device provided for mobile use, that is, in particular, a handheld PC, a PDA or a mobile radio telephone, jointly uses the hardware resources that are present in the motor vehicle equipment that is present for the purpose of implementing the function of a vehicle navigation device.

To do this, it is provided, for example, that the first, or an additional, interface of the device provided for mobile use is designed for transmitting the data generated by the navigation software to the second, or an additional interface of the vehicle.

Moreover, it is provided for this purpose, for example, that the data generated by the navigation software are driving instructions for the driver, which are provided to be output via an output device of the vehicle.

Alternatively or in supplement, it may also be provided that the first interface of the device provided for mobile use is also designed to receive operating signals of a vehicle component, having an operating unit, and that, in addition, an operating software of the device is designed to execute the operating signals received via the first interface into operating functions of the device.

### BRIEF DESCRIPTION OF THE DRAWING

FIG. 1 shows a block diagram of a navigation device according to the present invention, based on a device provided for mobile use, such as a handheld PC, a PDA or a mobile radio telephone.

### DETAILED DESCRIPTION

An important aspect of the present invention is the transmission of data present in a vehicle, especially a motor vehicle, such as a tachometer signal, a gyro signal, a reverse gear signal via a software interface and/or a wired or radio connection, such as Bluetooth, IRDA, WLAN to a mobile device, such as a mobile radio telephone, PDA or Smartphone, which are equipped with navigation software for carrying out a navigation functionality. These additional data make possible an improvement in accuracy during position finding or during the determination of a motion state of the vehicle in which such a navigation device is being operated. The mobile device is able to utilize the user interface of the car radio via an additional interface, for display (and, for instance, also Bluetooth Handsfree Profile).

The car radio, in this example the communication interface on the side of the vehicle, receives from its own sensors or from the vehicle network data such as a gyro signal, a tacho signal, GPS information, a driving in reverse signal. In addition, it has a wired or radio interface to the mobile device. The connection is designed dynamically. For safety aspects, a prior registration may be performed.

The navigation software is installed on the mobile device by data carrier, via a server, by PC or even directly by the car radio. The navigation software communicates via the connection with the car radio, scans the sensor data and thereby improves the navigation computation and display (improved position finding).

The mobile device utilizes either its own user interface or utilizes the user interface of the car radio, via the connection to the car radio via an additional software interface. Alternatively, the mobile device can transmit the driving instructions as data, which are then represented by the car radio.

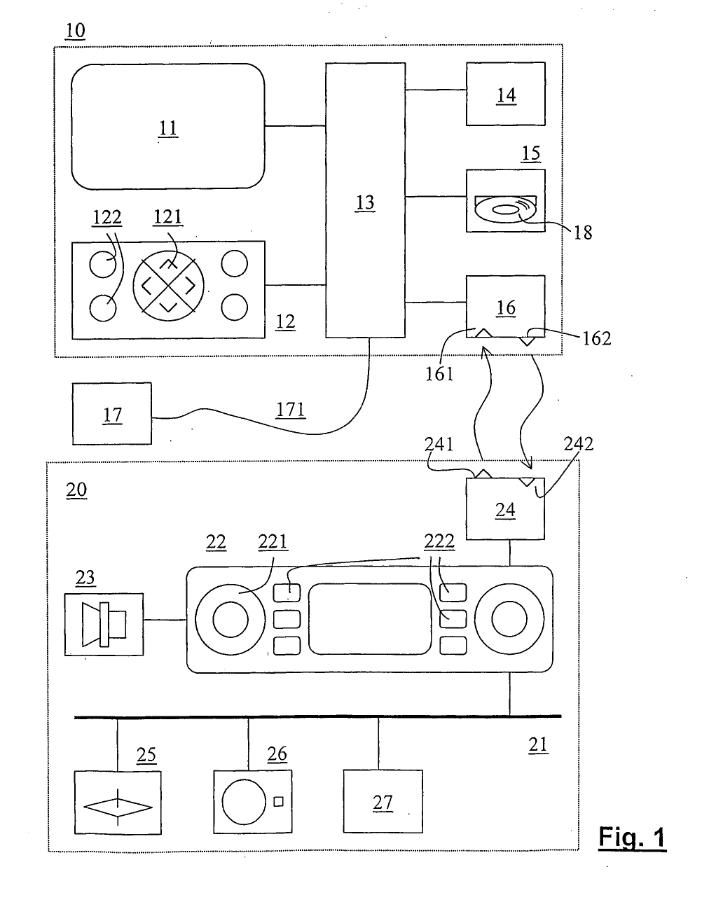

FIG. 1 shows a block diagram of a system according to the present invention for utilizing a device provided for mobile use, such as a mobile radio telephone, a handheld PC, a PDA (personal digital assistant) or a comparable device having an integrated computer or processor.

Device 10, subsequently also designated simply as PDA, has an output unit 11 in the form of a display. In addition, the device has an input unit 12 having operating elements in the form of a rocker key 121 for controlling a cursor on display 11 and in the form of additional key switches 122 for the input of operating instructions. Device 10 also has a processor 13 for processing operating software of the device which is stored in a memory 14, and also for processing navigation software. The navigation software, in this instance, is stored on an exchangeable data carrier 18, such as a memory chip card, which can be read out using an appropriate reading device 15.

The navigation software is developed to determine the position of the device, and thereby also of a vehicle in which the device is operated, from signals of a position-determining device or from sensor signals or other suitable data signals. The signal suitable for position determination may be, for example, signals of a satellite receiver 17, for receiving and evaluation GPS satellite signals, which is connected to the PDA via a cable or other communications connection. In this context, the GPS receiver may be implemented, for example, in the form of a so-called GPS mouse 17, that is, in its own little housing that is mounted on the dashboard of a motor vehicle. Alternatively, GPS receiver 17 may also be developed as a part of a usual vehicle navigation system installed in the vehicle, which may be accessed via a data bus 21 of the motor vehicle.

According to the present invention, such a PDA 10 has a first communications interface 161 having means to receive signals from a corresponding complementary (second) transmitting interface 241 of the vehicle. This first interface 161 is shown here as a part of an interface module 16, and is developed, for instance, to receive Bluetooth signals, IRDA signals or WLAN data signals.

Vehicle equipment 20 includes a data bus 21, to which various components are connected, such as a car radio 22, a circular compass, also called gyroscope or gyro 25, a tacho signal generator 26, acceleration sensors 27 and further components. Gyro compass 25 can be but does not have to be, for example, a part of a vehicle navigation system known per se, which is fixedly installed in the motor vehicle. Tacho signal generator 26, for instance, utilizes signals of an ABS sensor to generate a speed signal, which is utilized for the speed display in the vehicle, and also for a speed-dependent volume control of car radio 22. In the case of acceleration sensors 27, for example, accident detectors for triggering air bags are involved.

According to the present invention, vehicle equipment 20 has an additional interface module 24, which is connected to data bus 21. In the present case, the interface module is developed, for example, as a part of car radio 22. The above-named signals or sensor data are transmitted to first interface 161 of the device according to the present invention via one (the second) interface 241 of this additional interface module 24.

The navigation software and the position determination software of the device 10 are developed in such a way as to use these data, that is, especially position determination signals of GPS satellite receiver 17, signals of at least one wheel sensor, a speed signal, signals of at least one acceleration sensor, signals of at least one gyroscope and/or signals of a reverse driving detection for the purpose of an improved position determination and/or motion state detection. These data are preferably linked with one another to form a resulting vehicle position, and this resulting vehicle position is matched with data of a digital map (map matching) that is present on data carrier 18, in the sense of a plausibility check.

According to one advantageous refinement of the present invention, it is further provided that the PDA utilize not only its own output means 11, but additionally also further output means of vehicle equipment 20, for the purpose of route guidance using driving instructions as a function of an ascertained vehicle location and a computed route. These are particularly loudspeakers 23 connected to car radio 22, via which driving direction instructions may be output in spoken form.

To do this, the PDA has available the possibility not only of receiving data but also to transmit them. This takes place, in the present case, via an additional interface 162 developed as a transmitting interface which, in turn, may also be developed as a Bluetooth interface, an IRDA interface, a WLAN interface or even as a wired interface. The vehicle equipment has an appropriately corresponding second additional interface 242 for receiving signals or data transmitted by the PDA, which are reproduced by car radio 22 or rather loudspeaker 23 that is connected to it. Alternatively or in supplementation, these may be reproduced as an optical message on a display built into the vehicle, for instance, in an instrument panel which, for example, may be connected via the vehicle bus.

According to one further refinement, it may also be provided that, during operation in the vehicle, the PDA is able to be operated via operating elements of its equipment. Thus, car radio 22 has operating elements, in this case in the form of rotary knobs 221, for the pseudo-continuous setting of parameters, or for running through list entries, and also in the form of pressure-operated switches 222. The operating signals generated via these operating elements of operating surface in connection with the software of car radio 22 are able to be transmitted via second interface 241 and first interface 161 on computers 13 of the PDA, and are thus able to be used for operating the PDA.

1-7. (canceled)

8. A navigation device comprising:
a device for mobile use, including input and output elements, a processor for processing navigation software for position determination and for route computation, and a first interface for transmitting data into the device, the first interface being adapted, in an operation of the device in a motor vehicle, to read at least one of operating data and sensor data of at least one vehicle component into the device via a second interface of the motor vehicle.

9. The navigation device according to claim 8, wherein the navigation software uses the at least one of the operating data and sensor data read in via the first interface for at least one of (a) position determination and (b) determining a motion state of the vehicle.

10. The navigation device according to claim 8, wherein the at least one of the operating data and sensor data includes at least one of (a) signals of at least one wheel sensor, (b) a speed signal, (c) signals of at least one acceleration sensor, (d) signals of at least one gyroscope, and (e) signals of a detection of driving in reverse.

11. The navigation device according to claim 8, wherein the first interface of the device is adapted to transmit data generated by the navigation software to the second interface of the vehicle.

12. The navigation device according to claim 11, wherein the data generated by the navigation software are driving instructions for a driver, which are provided to be output via an output device of the vehicle.

13. The navigation device according to claim 8, wherein the first interface of the device is adapted to receive operating signals of a vehicle component that has an operating unit, and an operating software of the device is adapted to convert the operating signals received via the first interface to operating functions of the device.

14. A computer-readable medium containing navigation software for use in a device provided for mobile use, the navigation software including a software module which when executed by a processor performs at least one of the following:
utilizing operating data of a vehicle in which the device is operated, the operating data having been read in via an interface of the device; and
utilizing sensor data from sensors that are situated in the vehicle for at least one of (a) position determination and (b) determining a motion state of the vehicle.
